(19) United States
(12) Patent Application Publication
(10) Pub. No.: US 2022/0301308 A1
(43) Pub. Date: Sep. 22, 2022

(54) METHOD AND SYSTEM FOR SEMI-SUPERVISED CONTENT LOCALIZATION

(71) Applicant: GUANGDONG OPPO MOBILE TELECOMMUNICATIONS CORP., LTD., Dongguan (CN)

(72) Inventor: Jenhao Hsiao, Palo Alto, CA (US)

(21) Appl. No.: 17/832,354

(22) Filed: Jun. 3, 2022

Related U.S. Application Data
(63) Continuation of application No. PCT/CN2020/130208, filed on Nov. 19, 2020.
(60) Provisional application No. 62/944,604, filed on Dec. 6, 2019.

(51) Int. Cl. G06V 20/40; G06V 10/77

(52) U.S. Cl. CPC G06V 20/41; G06V 20/46; G06V 10/7715; G06V 20/49

(57) ABSTRACT

A special-purpose convolutional learning model architecture outputs a convolutional feature map at a last of its convolutional layers, then performs binary classification based on non-semantically labeled dataset. The convolutional feature map, containing a combination of low-spatial resolution features and high-spatial resolution features, in conjunction with a binary classification output of a special-purpose learning model having transferred learning from a pre-trained learning model, may be used to non-semantically derive a segmentation map. The segmentation map may reflect both low-spatial resolution and high-spatial resolution features of the original image on a one-to-one pixel correspondence, and thus may be utilized to highlight or obscure subject matter of the image in a contextually fitting manner at both a global scale and a local scale over the image, without semantic knowledge of the content of the image.

### CROSS-REFERENCE TO RELATED APPLICATIONS

The present application is a continuation of International Application No. PCT/CN2020/130208 filed on Nov. 19, 2020, which claims priority to U.S. patent application No. 62/944,604 filed on Dec. 6, 2019, the entire contents of which are incorporated herein by reference.

### BACKGROUND

User-generated content submitted to web-hosted applications and platforms is stored at servers and data centers in increasingly massive volumes, and such content is commonly unpredictable in nature. For example, user-generated videos may be stored at servers and data centers supporting video hosting platforms, social media platforms, messaging platforms, and the like may. Image content of user-submitted videos may capture a variety of semantic content. The same semantic content may be captured in widely different manners across different user-submitted videos, such that the same semantic content may be oriented differently, lit differently, partially obstructed in different manners, and the like.

The application of machine learning technologies, such as computer vision, to video content may present challenges with regard to identifying semantic content. One common approach is to train machine learning models using samples of video data having semantic segmentation applied thereto, wherein pixels of video data may be divided into partitions and labeled with semantic meaning. However, as semantic content of video data differs per frame, application of semantic segmentation to each individual frame of image data may be arduous and labor-intensive, especially with regard to user-generated videos, which may be extensively heterogeneous in semantic content.

Moreover, the identification of semantic subject matter of user-generated video content may bear incur human costs other than labor costs. For example, the manual review of user-generated video content which is disturbing or traumatic, such as those depicting violence, harmful acts, or shocking imagery, is known to visit substantial psychological tolls on human reviewers deployed by major social media platforms. Thus, there is a need for computer vision techniques which may be applied based on widely diverse and heterogeneous samples of video content to distinguish content of interest within individual images, while avoiding the process of semantic segmentation and labeling.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an architectural diagram of a learning system running a learning model according to example embodiments of the present disclosure.

FIG. 2 illustrates a diagram of a learning model according to example embodiments of the present disclosure.

FIG. 3 illustrates a flowchart of a localization mapping method according to example embodiments of the present disclosure.

FIG. 4 illustrates an example of applying a filter to an image according to a segmentation map.

FIG. 5 illustrates a system architecture of a system configured to perform non-semantic localization according to example embodiments of the present disclosure.

FIG. 6 illustrates an example system for implementing the processes and methods described above for implementing non-semantic localization.

### DESCRIPTION OF EMBODIMENTS

Systems and methods discussed herein are directed to implementing image content localization, and more specifically methods and systems for semi-supervised content localization in video data.

A learning model, according to example embodiments of the present disclosure, may be a defined computation algorithm executable by one or more processors of a computing system to perform tasks that include processing input having various parameters and outputting results. A learning model may be, for example, a layered model such as a deep neural network, which may have a fully-connected structure, may have a feedforward structure such as a convolutional neural network (“CNN”), may have a backpropagation structure such as a recurrent neural network (“RNN”), or may have other architectures suited to the computation of particular tasks. Tasks may include, for example, classification, clustering, matching, regression, semantic segmentation, and the like.

Tasks may provide output for the performance of functions supporting computer vision functions. For example, a computer vision function may be image content localization, as shall be described herein.

A learning model may run on a computing system, which includes computing resources which may run a learning model to perform one or more tasks as described above.

In the field of computer vision, learning models may be pre-trained with parameters, and may be stored on storage of the computing system and, upon execution, loaded into memory of the computing system. For example, with regard to tasks relating to computer vision and related functions, commonly available pre-trained image classifier learning models include ResNet and the like.

A variety of learning models implemented for computer vision tasks are based on pre-trained models such as ResNet. Common to the architectures of these learning models is an encoder-decoder structure, including an encoder made up of stacks of convolutional layers and a decoder made up of stacks of deconvolutional layers. Samples of image data, including video data containing multiple frames of image data, may be input into a first layer of an encoder, convoluted through convolutional layers of the decoder, and output from a last layer of the encoder. Subsequently, samples of image data may be input into a first layer of a decoder, deconvoluted through deconvolutional layers of the decoder, and output from a last layer of the decoder.

In a learning model architecture, encoder and decoder architectures cause some layers (that is, later layers of encoders and earlier layers of decoders) to receive images having lower spatial resolution, and other layers (that is, earlier layers of encoders and later layers of decoders) to receive images having higher spatial resolution. In a convolution from one convolutional layer to another convolution layer, image data may be down-sampled in a convolution at the earlier layer, and then input into the subsequent layer. In a deconvolution from one deconvolutional layer to another deconvolutional layer, image data may be up-sampled in a deconvolution at the earlier layer, and then input into the subsequent layer. High-spatial resolution image data may contain large-scale features of the image data which may be detected and transformed in various manners, such as whole objects or groups of objects and inter-object relationships; low-spatial resolution image data as input may contain small-scale features of the image data which may be detected and transformed in various manners, such as parts of objects, individual objects, and objects at fine spatial resolutions.

Learning model architectures may further include skip connections from encoder layers and decoder layers which correspond to a same image resolution. At decoder layers, image data (which has already been down-sampled in the encoder layers), even upon up-sampling, may fail to retain features lost as a result of down-sampling. Skip connections may allow features of image data at encoder layers (prior to being lost through down-sampling) to be conveyed to decoder layers.

Conventionally, computing systems may run learning models as described above to perform tasks wherein semantic information are detected from any combination of features of image data at different spatial resolutions, output by any number of encoder layers and decoder layers. For example, learning models may perform classification tasks to semantically identify objects in image data, semantically identify subject matter of image data, and the like. Or, learning models may perform semantic segmentation tasks or localization tasks to identify pixels and boundaries of image data which include a particular semantic subject. Such learning models may be based upon, or may be connected to, pre-trained learning models such as ResNet.

However, such semantic tasks in computer vision rely upon semantically labeled sample image data, which must generally be labeled by manual human review of individual samples of image data. In video content, wherein numerous individual frames of image data containing a variety of subject matters may exist in a single video; a single video may contain a variety of heterogeneous subject matters; and users of a hosted application or platform may generate video content in massive quantities, rendering manual labeling of image data highly arduous. Consequently, pre-trained learning models such as ResNet, and special-purpose learning models based thereupon or connected thereto, rely upon published labeled sample image datasets, which have effectively become industry standards.

A limitation of such pre-trained learning models and published datasets is that they have become generally adapted to computer vision tasks based in semantic information. While such applications of computer vision may be powerful, in order to refine such learning models for specialized tasks, and train special-purpose learning models based thereon or connected thereto, similar arduous labor burdens, in the nature of manual reviewing and semantic labeling of massive quantities of sample image data (such as, for example, video data) may be incurred in the process. In particular, in computer vision applications targeting user-generated video content, the unpredictable and widely heterogeneous semantic content commonly found in user-generated video content may greatly complicate semantic labeling.

Thus, example embodiments of the present disclosure provide a special-purpose learning model architecture which derives non-semantic information from a pre-trained learning model, and trains an output layer based on a non-semantically labeled sample image dataset. Such a special-purpose learning model may rely upon image feature information derived from a pre-trained learning model (regardless of whether the image feature information contains semantic information), and may be trained to perform non-semantic localization of image data, enabling the model to be trained without incurring costs of manual review in generating semantic labeling of image datasets.

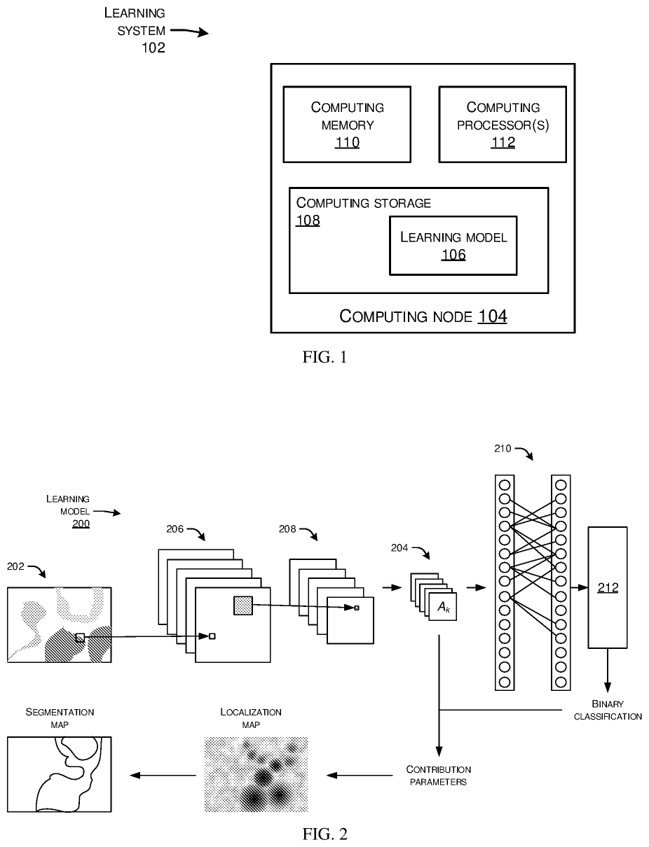

FIG. 1 illustrates an architectural diagram of a learning system 102 running a learning model according to example embodiments of the present disclosure. A computing system may be operative to provide computing resources and storage operative to run a learning model to compute one or more tasks as described herein. server host functionality for hosting computing resources, supported by a computing host such as a data center hosting a learning model. While this figure illustrates a possible architectural embodiment of a learning system as described above, it should not be considered limiting as to possible implementations of a learning system 102, which may be implemented according to any suitable computing architecture incorporating computing resources, storage, and the like as shall be described subsequently.

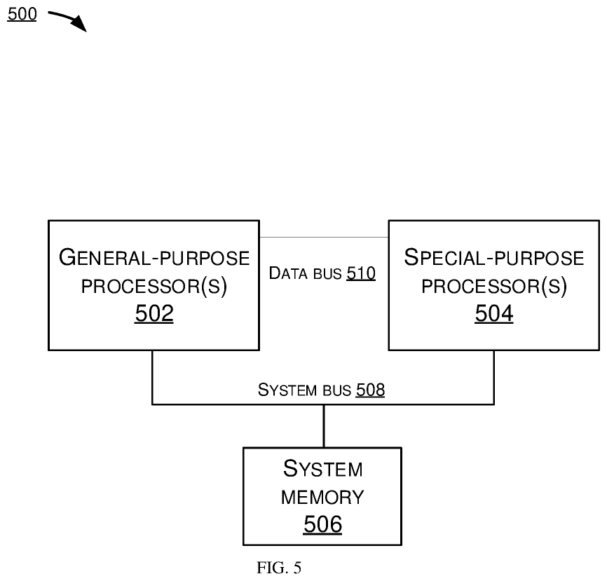

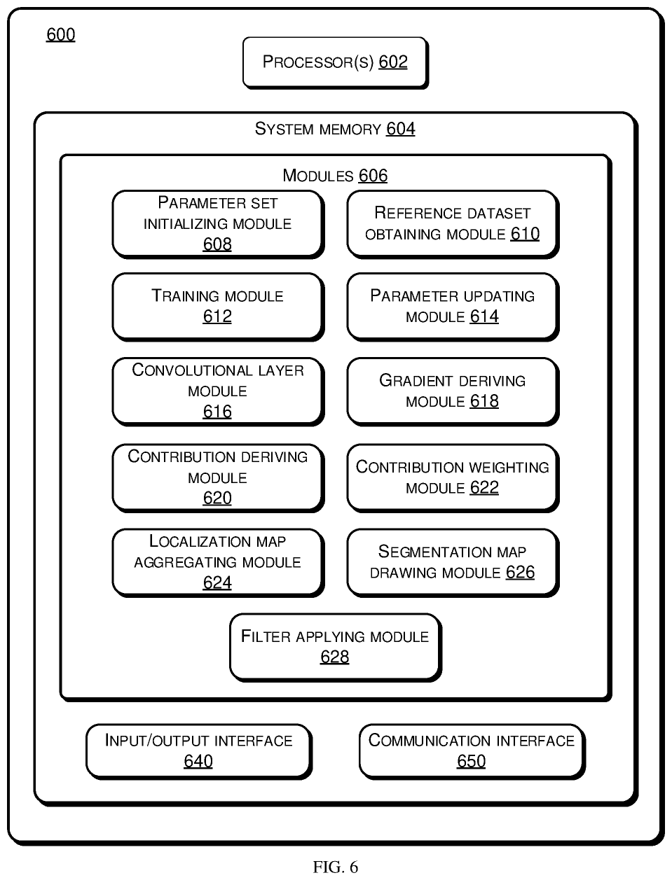

The learning system 102 may be implemented on one or more computing nodes 104, where each computing node 104 may be implemented as a physical computing system or a virtualized computing system as subsequently described with reference to FIG. 5. A learning model 106 may be implemented on one or more computing nodes 104, where it may be stored on computing storage 108 of the computing node 104 (which may be one or more physical or virtualized storage devices), and may be loaded into computing memory 110 of the computing node 104 (which may be one or more physical or virtualized memories). Once the learning model 106 is loaded into computing memory 110, one or more processors 112 of the one or more computing nodes 104 (which may be one or more physical or virtualized processors, as shall be subsequently described) may execute one or more sets of computer-executable instructions of the learning model 106 to perform computations with regard to tasks, such as non-semantic localization, as described herein.

One or more processors 112 of the one or more computing nodes 104 may be special-purpose computing devices facilitating computation of matrix arithmetic computing tasks. For example, one or more processors 112 may be one or more special-purpose processors as described above, including accelerators such as Graphics Processing Units (“GPUs”), Neural Network Processing Units (“NPUs”), and the like.

According to example embodiments of the present disclosure, a learning model 106 may include some number of different modules. Modules of a learning model, as described subsequently in further detail with reference to FIG. 2, may each be executed by a processor among the one or more processors 112 of one or more computing nodes 104. Different modules may be executed by a same processor concurrently, serially, or in any other order on different cores or different threads, or may be executed by different processors concurrently, serially, or in any other order, and each module may perform computation concurrently relative to each other module.

FIG. 2 illustrates a diagram of a learning model 200 according to example embodiments of the present disclosure. As illustrated herein, sample image data 202 is input into the learning model 200, and a convolutional feature map 204 of the sample image data 202 is ultimately output from the learning model 200.

The learning model 200 includes a number of convolutional layers 206. Each convolutional layer 206 may receive image data from a preceding layer as input (where the first convolutional layer 206 may receive image data from an input layer, which is not illustrated herein for simplicity). Each convolutional layer 206 may perform a convolution operation upon image data to output convolutional feature vectors of the image data. Convolutional feature vectors output by a convolutional layer 206 may be organized in some number of channels, each channel including some number of dimensions of feature values. Each convolutional layer 206 may further apply a non-linear transformation to image data by an activation function such as a rectifier, by a Rectified Linear Unit (“ReLU”). Convolutional layers 206 may be interconnected by forward propagation, backpropagation, and such operations as known to persons skilled in the art. The last of the convolutional layers 206 may output a convolutional feature map 204; for the purpose of describing example embodiments of the present disclosure, the convolutional feature map 204 output by the last convolutional layer 206 may be said to have n channels.

Additionally, in between convolutional layers 206, the learning model 200 include a number of pooling layers 208. A pooling layer 208 may perform a pooling operation upon convolutional feature vectors output by a convolutional layer 206. A pooling operation may be any suitable operation as known to persons skilled in the art reducing dimensionality of each channel of convolutional feature vectors, such as average pooling operations, max pooling operations, and the like.

Additionally, following the convolutional layers 206, the learning model 200 includes a number of fully-connected layers 210. Herein, each fully-connected layer 210 may receive each convolutional feature vector output by a previous layer, and may perform one or more operations upon the set of convolutional feature vectors output by the previous layer. For example, a fully-connected layer 210 may perform a weighting operation upon the set of convolutional feature vectors so that each convolutional feature vector is weighted according to a trained parameter set. The weighting operation may be implemented as, for example, a dot product operation between the set of convolutional feature vectors and the parameter set. The last of the fully-connected layers 210 may output a set of weighted convolutional feature vectors.

According to example embodiments of the present disclosure, the learning model 200 further includes a binary classification layer 212. The binary classification layer 212 may be configured to receive a set of weighted convolutional feature vectors from the fully-connected layers 210 as input. The binary classification layer 212 may perform one or more classifying operations upon a set of weighted convolutional feature vectors which result in one of two possible outputs, each output corresponding to one of two classifications. For example, the classifying operations may include a softmax function, wherein a normalizing operation is applied to the weighted convolutional feature vectors, yielding a probability score over a probability distribution (for example, a probability score within the interval (0, 1), or any other such suitable distributions). For a same feature vector, a different score may be yielded for each different classification among the binary classifications. The classifying operations may further include classifying each feature vector depending on whether each of its probability scores falls below or above a respective threshold, where each respective threshold may be a preset probability score. For example, the binary classification layer 212 may output a first classification in the event that a first probability score corresponding to the first classification is below or above a first threshold, and/or output a second classification corresponding to the second classification in the event that a second probability score is below or above a second threshold.

A learning model 200 according to example embodiments of the present disclosure may be trained by steps as described below.

The learning model may be stored on storage of any learning system as described above having one or more processor(s) operative to execute one or more sets of computer-executable instructions of the learning model.

Reference datasets may generally be any labeled dataset wherein each individual image sample, including individual frames of video samples, is labeled to indicate a binary classification. For example, each individual image may be labeled to indicate containing subject matter of interest (a “positive classification”), or not containing subject matter of interest (a “negative classification”). A positive classification may correspond to a probability score of 1 along the above-mentioned example interval, and a negative classification may correspond to a probability score of 0 along the above-mentioned example interval.

According to example embodiments of the present disclosure, images of a reference dataset need not be semantically labeled in any fashion, such as to indicate different types of subject matter. Images of a reference dataset also need not be labeled with segmentations within the image; a label according to example embodiments of the present disclosure may be understood as applying to an entire image. A positive classification need not apply to each and every pixel of an entire image (for example, not each and every pixel of an entire image need contain subject matter of interest), though a negative classification should apply to most, or all, pixels of an entire image (for example, most or all pixels of the image should be substantially absent of subject matter of interest).

Thus, labeled datasets according to example embodiments of the present disclosure may be labeled by manual review, but each image sample may be merely labeled to indicate a binary classification upon cursory review, which merely needs to identify whether, for example, subject matter of interest is substantially absent from the entire image or not. Thus, generation of labels may be made efficient, as many consecutive frames of a video may be labeled uniformly. Moreover, the simple, binary nature of the labels may enable labels to be assigned quickly. All this may greatly reduce the time that manual reviewers need to engage with each individual image. In the event that subject matter of interest is, for example, disturbing or traumatic content, such as violence, harmful acts, or shocking imagery, psychological burden of the review and labeling process may be alleviated to some extent.

A loss function, or more generally an objective function, may be any mathematical function having an output which may be optimized during the training of a learning model.

A learning model may be trained on at least one loss function to learn a parameter set which may be used in computation of tasks, such as, for example, a weighting operation as described above with reference to FIG. 1. The at least one loss function may be any objective function known to persons skilled in the art as operative for the learning model to be trained on. For example, the at least one loss function may be a cross-entropy loss function utilized in classification computing as known to persons skilled in the art, such as a binary cross-entropy (“BCE”) loss function utilized in binary classification computing.

A reference dataset may be obtained for the task to be computed, and a parameter set may be initialized. The reference dataset may be obtained from user-generated content, such as user-generated video content according to example embodiments of the present disclosure. To avoid problems as known to persons skilled in the art wherein the parameter set may vanish to 0 values or explode to infinity values, a parameter set initialization should generally not be values of 0 or 1 or any other arbitrary value, but may be initialized based on parameter sets learned by a pre-trained learning model, such as ResNet, and may be further fine-tuned during training according to example embodiments of the present disclosure as described herein.

The learning model may be trained on a loss function for multiple iterations, taking reference data of a set batch size per iteration. The learning model may be trained for a set number of epochs, an epoch referring to a period during which an entire dataset (i.e., the above-mentioned reference dataset) is computed by the learning model once; the parameter set is then updated based on computations performed during this period.

The parameter set may be updated according to gradient descent (“GD”) (i.e., updated after computation completes for an epoch), stochastic gradient descent (“SGD”), or any other suitable process for updating parameter sets as known to persons skilled in the art.

According to example embodiments of the present disclosure, during the first few epochs of training, at least some layers of the learning model may be frozen, so that weights of the parameter set corresponding to those frozen layers are not updated during those epochs. This may achieve a transfer learning effect, so that parameter sets of the learning model being trained may be initialized based on a pre-trained model, such as ResNet, gaining the benefit of training already performed by the pre-trained model. After these first few epochs, the frozen layers may be unfrozen, so that all weights of the parameter set are updated by SGD after each subsequent epoch. During these subsequent epochs, training of the learning network may further fine-tune the previous training performed by the pre-trained model.

Subsequent to the learning model being trained on the learning system, the learning system may store the learned parameter set. Subsequent computation of tasks such as non-semantic localization by the learning model may be performed by the learning system as follows. The learning system may load the parameter set into memory and run one or more sets of computer-executable instructions of the learning model, which may configure one or more processors of the learning model to compute non-semantic localization for sample image data input into the learning model, based on the parameter set.

Based on the architecture of a learning model as described above, a convolutional feature map 204 output by the last of the convolutional layers 206 is expected to include a combination of low-spatial resolution features (which may include features detectable over a local scope of the image data) obtained through convolutions, and high-spatial resolution features (which may include features detectable over a global scope of the image data) forwarded from input image data by way of skip connections. By this architecture, gradient data computed by earlier convolutional layers is propagated to the final convolutional layer. Additionally, by initializing the learning model based on a pre-trained model, a trained learning model according to example embodiments of the present disclosure may obtain, by transferred learning from the pre-trained model, at least some convolutional features which are based in semantic features of image data (though the trained learning model according to example embodiments of the present disclosure does not ultimately compute a task based in semantic features, as, outside of pre-training, the learning model according is not trained using semantic labels).

It is expected that the convolutional feature map 204 output by the last of the convolutional layers 206 contains spatial features at a variety of high-level and low-level spatial resolutions, and also contains semantic features at a variety of high-level and low-level spatial resolutions. Such spatial features and/or semantic features of the convolutional feature map 204 may be used in conjunction with output of the binary classification layer 212, according to example embodiments of the present disclosure, to derive a localization map as shall be described in more detail subsequently.

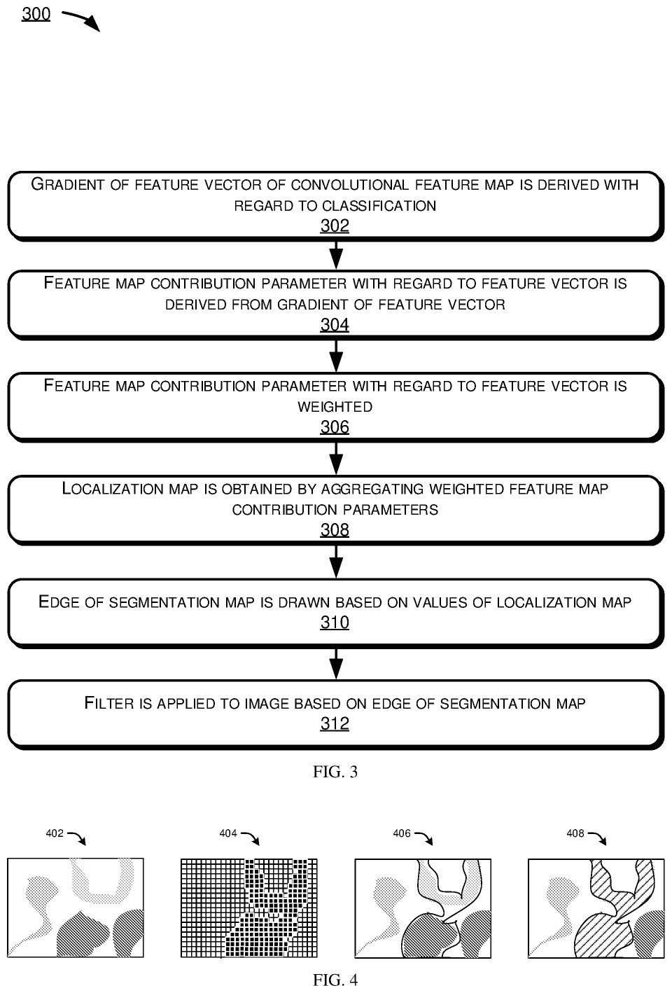

FIG. 3 illustrates a flowchart of a localization mapping method 300 according to example embodiments of the present disclosure.

At a step 302, a gradient of a feature vector of a convolutional feature map is derived with regard to a classification.

According to example embodiments of the present disclosure, since the learning model 200 ultimately outputs a binary classification, two classifications may be relevant: a negative classification and a positive classification. A classification may be denoted by c herein. For the purpose of understanding example embodiments of the present disclosure, the subsequent description may be read with c representing a positive classification.

Deriving a gradient of a classification from a feature may include computing a partial derivative of a probability score of a feature of the convolutional feature map with regard to a class c over a k-th feature vector A^{k} of the convolutional feature map among n channels (the probability score being denoted by y^{c} herein). It should be understood that the probability score may be of some or all feature vectors of the convolutional feature map; features of a different convolutional feature map (i.e., a convolutional feature map output based on a different input image) may result in a different probability score, and features of the same convolutional feature map with regard to a classification other than class c (for example, the negative classification rather than the positive classification) may also result in a different probability score.

The convolutional feature map may include an n number of channels, and each k-th feature vector of the convolutional feature map may be denoted as A^{k}. Moreover, each convolutional feature map may include feature vectors containing feature values of individual pixels of the original image data that was input into the learning model to generate the convolutional feature map. Due to the final of the convolutional layers 206 outputting at full spatial resolution of the original input image, and due to skip connections passing image features at full spatial resolution to the final of the convolutional layers 206, the feature values may include as many pixels as the original input image data contained. Each pixel may be identified by coordinates i and j relative to each other channel along a first dimension and a second dimension, respectively. The number of pixels may be denoted as Z, where Z is the product of i and j. Thus, the (i, j) pixel coordinate feature value of the k-th feature vector of the convolutional feature map may be denoted as A^{k}ᵢⱼ.

A partial derivative may be denoted by the following:

$$\frac{\partial {y}^{c}}{\partial {A}_{ij}^{k}}$$

This derives the partial gradient at each individual pixel over the convolutional feature map for the k-th feature vector.

At a step 304, a feature map contribution parameter with regard to the feature vector is derived from the gradient of the feature vector.

Global average pooling may be performed upon the gradient as follows:

$${α}_{k}^{c} = \frac{1}{Z} {Σ}_{i} {Σ}_{j} \frac{\partial {y}^{c}}{\partial {A}_{ij}^{k}}$$

The partial derivative is thus summed over each individual pixel along both a first dimension and a second dimension, and the sum is divided by the number of pixels. The resulting value, ack, shall be referred to herein as a feature map contribution parameter. The feature map importance parameter indicates contribution of a k-th feature vector of the convolutional feature map towards a classification of the class c (over all other possible classes), normalized over the aggregate of all pixels of the convolutional feature map.

At a step 306, the feature map contribution parameter with regard to the feature vector is weighted.

The feature map contribution parameter may be weighted by multiplication with the corresponding feature vector itself:

αₖ^{c}A^{k}

At a step 308, a localization map is obtained by aggregating weighted feature map contribution parameters.

The weighted feature map contribution parameters may be summed for all k-th feature vectors, and then a non-linear transformation may be applied thereto by an activation function such as a rectifier, by a ReLU.

M=ReLU(Σₖαₖ^{c}A^{k})

For example, the non-linear transformation may increase aggregated weighted feature map contribution parameters having positive values, and decrease, or reduce to zero, aggregated weighted feature map contribution parameters having negative values. Since aggregated weighted feature map contribution parameters have positive values where they contribute highly to a positive classification, and have negative values where they make little or no contribution to a positive classification, it is expected that those feature values which contribute to a positive classification will be emphasized, and those feature values which do not contribute to a positive classification will be de-emphasized.

The output of the non-linear transformation may be a localization map M, having a localization map value Mᵢⱼ at each (i, j) pixel coordinate. Thus, the contribution parameters represent backflow of information from the classification, by which the localization map is obtained.

At a step 310, an edge of a segmentation map is drawn based on values of the localization map.

A segmentation map S according to example embodiments of the present disclosure may include a same number of pixels as the localization map, and, thereby, a same number of pixels as the original image data input into the learning model. One or more edges may be drawn over the segmentation map, and each pixel Sᵢⱼ of the one or more edges may be translated to a pixel (i, j) of the original image data input into the learning model such that they may be overlaid over pixel data of the original image data. As the pixels of the segmentation map are one-to-one to the localization map, the convolutional feature map, and the original image data, no re-sampling needs to be performed on either the segmentation map or the original image data.

An edge may be drawn over the segmentation map by assigning values of 1 to each pixel Sᵢⱼ corresponding to a localization map value Mᵢⱼ (for the same (i, j) pixel) greater than or equal to a segmentation threshold value, and assigning values of 0 to each pixel Sᵢⱼ corresponding to a localization map value Mᵢⱼ (for the same (i, j) pixel) less than the segmentation threshold value. The segmentation threshold value may denote a level of contribution to a positive classification, by a localization map value, which exceeds a preset value reflecting a level of interest. For example, the segmentation threshold value may be midway over a range of possible localization map values, or may be any other experimentally determined suitable value for edges of the segmentation map to reflect subject matter of interest over those pixels having values of 1 assigned thereto.

At a step 312, a filter is applied to an image based on an edge of the segmentation map.

The image may be the original image data input into the learning model, which may be, for example, an individual frame of video data. A filter may be applied to all pixels (i, j) of the image corresponding to Sᵢⱼ values of 1 assigned in the segmentation map.

A filter may be any suitable signal filter suitable to distinguish filtered pixels from non-filtered pixels, and may, for example, highlight the filtered pixels or obscure the filtered pixels. For example, a filter may be a Gaussian blur filter implemented by the following:

$$G = \frac{1}{2 {πσ}^{2}} {e}^{- \frac{{x}^{2} + {y}^{2}}{2 {σ}^{2}}}$$

Herein, x denotes a distance from an origin of the filter in a first dimension; y denotes a distance from the origin of the filter in a second dimension; and σ denotes standard deviation of the Gaussian probability distribution. Applying a Gaussian blur based on the segmentation map may cause pixels partitioned by an edge of the segmentation map to become obfuscated due to the blurring effect.

FIG. 4 illustrates an example of applying a filter to an image according to a segmentation map. An original image 402 has a one-to-one pixel correspondence with a segmentation map 404 S wherein some pixels Sᵢⱼ are assigned values of 1 (shown as filled in), and other pixels are assigned values of 0 (shown as empty). A segmented image 406 is shown having edges of the segmentation map 404 overlaid thereupon. A filtered image 408 is shown having a filter applied to all pixels (i, j) of the image corresponding to Sᵢⱼ values of 1 assigned in the segmentation map.

It may be seen by FIG. 4 that, according to example embodiments of the present disclosure, the segmentation map may cause pixels (i, j) of the image corresponding to subject matter of interest to be assigned Sᵢⱼ values of 1. This may be accomplished without the use of semantically labeled reference data, and without the use of a special-purpose learning model trained using semantically labeled reference data. Thus, filters may be applied without the use of semantic labels, decreasing the labor burden of generating such labels.

Furthermore, due to a one-to-one pixel correspondence between the image and the segmentation map, the filter may track pixels of the original image in a precise manner, and may provide a visual appearance which is true to context of the original image.

The filter may be applied non-destructively, or may be applied destructively, to the pixels of the image. Over an entire video file, each frame classified as having a positive classification may have a filter applied in this manner, while each frame classified as having a negative classification may not have a filter applied thereto. Consequently, the non-semantic localization and filtering process may be autonomous, with a basis in semi-supervised machine learning, and may be sensitive to heterogeneous contexts of user-generated video data over both global and local scales within each image of the video data.

FIG. 5 illustrates a system architecture of a system 500 configured to perform non-semantic localization according to example embodiments of the present disclosure.

A system 500 according to example embodiments of the present disclosure may include one or more general-purpose processor(s) 502 and one or more special-purpose processor(s) 504. The general-purpose processor(s) 502 and special-purpose processor(s) 504 may be physical or may be virtualized and/or distributed. The general-purpose processor(s) 502 and special-purpose processor(s) 504 may execute one or more instructions stored on a computer-readable storage medium as described below to cause the general-purpose processor(s) 502 or special-purpose processor(s) 504 to perform a variety of functions. Special-purpose processor(s) 504 may be computing devices having hardware or software elements facilitating computation of neural network computing tasks such as training and inference computations. For example, special-purpose processor(s) 504 may be accelerator(s), such as Neural Network Processing Units (“NPUs”), Graphics Processing Units (“GPUs”), implementations using field programmable gate arrays (“FPGAs”) and application specific integrated circuits (“ASICs”), and/or the like. To facilitate computation of tasks such as vector multiplication, special-purpose processor(s) 504 may, for example, implement engines operative to compute mathematical operations such as vector operations.

A system 500 may further include a system memory 506 communicatively coupled to the general-purpose processor(s) 502 and the special-purpose processor(s) 504 by a system bus 508. The system memory 506 may be physical or may be virtualized and/or distributed. Depending on the exact configuration and type of the system 500, the system memory 506 may be volatile, such as RAM, non-volatile, such as ROM, flash memory, miniature hard drive, memory card, and the like, or some combination thereof.

The system bus 508 may transport data between the general-purpose processor(s) 502 and the system memory 506, between the special-purpose processor(s) 504 and the system memory 506, and between the general-purpose processor(s) 502 and the special-purpose processor(s) 504. Furthermore, a data bus 510 may transport data between the general-purpose processor(s) 502 and the special-purpose processor(s) 504.

Datasets may be transported to special-purpose processor(s) 504 over a system bus 508 or a data bus 510, where training of learning models and computation of non-semantic localization by learning models may be performed by the special-purpose processor(s) 504 on the data series as described herein, and output segmentation maps as described herein.

FIG. 6 illustrates an example system 600 for implementing the processes and methods described above for implementing non-semantic localization.

The techniques and mechanisms described herein may be implemented by multiple instances of the system 600, as well as by any other computing device, system, and/or environment. The system 600 may be a networked system composed of multiple physically networked computers or web servers providing physical or virtual computing resources as known by persons skilled in the art. Examples thereof include learning systems as described above with reference to FIG. 1. The system 600 shown in FIG. 6 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 600 may include one or more processors 602 and system memory 604 communicatively coupled to the processor(s) 602. The processor(s) 602 and system memory 604 may be physical or may be virtualized and/or distributed. The processor(s) 602 may execute one or more modules and/or processes to cause the processor(s) 602 to perform a variety of functions. In embodiments, the processor(s) 602 may include a central processing unit (“CPU”), a GPU, an NPU, any combinations thereof, or other processing units or components known in the art. Additionally, each of the processor(s) 602 may possess its own local memory, which also may store program modules, program data, and/or one or more operating systems.

Depending on the exact configuration and type of the system 600, the system memory 604 may be volatile, such as RAM, non-volatile, such as ROM, flash memory, miniature hard drive, memory card, and the like, or some combination thereof. The system memory 604 may include one or more computer-executable modules 606 that are executable by the processor(s) 602. The modules 606 may be hosted on a network as services for a data processing platform, which may be implemented on a separate system from the system 600.

The modules 606 may include, but are not limited to, a parameter set initializing module 608, a reference dataset obtaining module 610, a training module 612, a parameter updating module 614, a convolutional layer module 616, a gradient deriving module 618, a contribution deriving module 620, a contribution weighting module 622, a localization map aggregating module 624, a segmentation map drawing module 626, and a filter applying module 628.

The parameter set initializing module 608 may be configured to initialize a parameter set prior to training a learning model on a reference dataset as described above.

The reference dataset obtaining module 610 may be configured to obtain a reference dataset as described above.

The training module 612 may be configured to train a learning model on a loss function as described above.

The convolutional layer module 614 may be configured to receive input features, perform convolution operations thereon, and output convoluted features as described above.

The gradient deriving module 618 may be configured to derive a gradient of a feature vector of a convolutional feature map as described above with reference to FIG. 3.

The contribution deriving module 620 may be configured to derive a feature map contribution parameter with regard to the feature vector as described above with reference to FIG. 3.

The contribution weighting module 622 may be configured to weight the feature map contribution parameter with regard to the feature vector as described above with reference to FIG. 3.

The localization map aggregating module 624 may be configured to obtain a localization map by aggregating weighted feature map contribution parameters as described above with reference to FIG. 3.

The segmentation map drawing module 626 may be configured to draw an edge of a segmentation map is based on values of the localization map as described above with reference to FIG. 3.

The filter applying module 628 may be configured to apply a filter to an image based on an edge of the segmentation map as described above with reference to FIG. 3.

The system 600 may additionally include an input/output (I/O) interface 640 and a communication module 650 allowing the system 600 to communicate with other systems and devices over a network, such as the data processing platform, a computing device of a data owner, and a computing device of a data collector. The network may include the Internet, wired media such as a wired network or direct-wired connections, and wireless media such as acoustic, radio frequency (RF), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 2-4. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

By the abovementioned technical solutions, the present disclosure provides a special-purpose convolutional learning model architecture which outputs a convolutional feature map at a last of its convolutional layers, then performs binary classification based on non-semantically labeled dataset. The convolutional feature map, containing a combination of low-spatial resolution features and high-spatial resolution features, in conjunction with a binary classification output of a special-purpose learning model having transferred learning from a pre-trained learning model, may be used to non-semantically derive a segmentation map. The segmentation map may reflect both low-spatial resolution and high-spatial resolution features of the original image on a one-to-one pixel correspondence, and thus may be utilized to highlight or obscure subject matter of the image in a contextually fitting manner at both a global scale and a local scale over the image, without semantic knowledge of the content of the image.

Example Clauses

A. A method comprising: deriving a gradient of a feature vector of a convolutional feature map; deriving a feature map contribution parameter with regard to the feature vector from the gradient of the feature vector; obtaining a localization map by aggregating feature map contribution parameters; and drawing an edge of a segmentation map based on values of the localization map.

B. The method as paragraph A recites, wherein the gradient of the feature vector is derived with regard to a classification.

C. The method as paragraph B recites, wherein the classification comprises one of two classes.

D. The method as paragraph B recites, wherein deriving the gradient of the feature vector comprises computing a partial derivative of a probability score of a feature of the convolutional feature map with regard to the classification over a feature vector of the convolutional feature map.

E. The method as paragraph D recites, wherein deriving the feature map contribution parameter comprises normalizing the partial derivative over each pixel of the convolutional feature map.

F. The method as paragraph E recites, wherein normalizing the partial derivative comprises summing the partial derivative over each pixel of the convolutional feature map, and dividing the sum by the number of pixels.

G. The method as paragraph A recites, further comprising weighting the feature map contribution parameter with regard to the feature vector.

H. The method as paragraph G recites, wherein weighting the feature map contribution parameter comprises multiplying the feature map contribution parameter by the feature vector.

I. The method as paragraph G recites, wherein aggregating feature map contribution parameters comprises aggregating weighted feature map contribution parameters.

J. The method as paragraph A recites, wherein aggregating feature map contribution parameters comprises summing a plurality of feature map contribution parameters for different corresponding feature vectors.

K. The method as paragraph J recites, wherein aggregating feature map contribution parameters further comprises applying a non-linear transformation to the summed plurality of feature map contribution parameters.

L. The method as paragraph K recites, wherein the non-linear transformation comprises a rectifier function.

M. The method as paragraph A recites, wherein the convolutional feature map has a one-to-one pixel correspondence to the localization map.

N. The method as paragraph M recites, wherein drawing an edge of a segmentation map comprises assigning a first value to a pixel of the segmentation map corresponding to a first range of localization map values, and assigning a second value to a pixel of the segmentation map corresponding to a second range of localization map values exclusive of the first range of localization map values.

O. The method as paragraph N recites, wherein the first range of localization map values and the second range of localization map values are separated by a segmentation threshold value.

P. The method as paragraph A recites, further comprising applying a filter to an image based on an edge of the segmentation map.

Q. The method as paragraph P recites, wherein the image has a one-to-one pixel correspondence to the segmentation map.

R. The method as paragraph Q recites, wherein the filter is applied to a pixel of the image corresponding to pixels of the segmentation map having a first value assigned.

S. The method as paragraph P recites, wherein the filter comprises a Gaussian blur filter.

T. A system comprising: one or more processors; and memory communicatively coupled to the one or more processors, the memory storing computer-executable modules executable by the one or more processors that, when executed by the one or more processors, perform associated operations, the computer-executable modules comprising: a gradient deriving module configured to derive a gradient of a feature vector of a convolutional feature map; a contribution deriving module configured to derive a feature map contribution parameter with regard to the feature vector from the gradient of the feature vector; a localization map aggregating module configured to obtain a localization map by aggregating feature map contribution parameters; and a segmentation map drawing module configured to draw an edge of a segmentation map based on values of the localization map.

U. The system as paragraph T recites, wherein the gradient deriving module is configured to derive the gradient of the feature vector with regard to a classification.

V. The system as paragraph U recites, wherein the classification comprises one of two classes.

W. The system as paragraph U recites, wherein the gradient deriving module is configured to derive the gradient of the feature vector by computing a partial derivative of a probability score of a feature of the convolutional feature map with regard to the classification over a feature vector of the convolutional feature map.

X. The system as paragraph W recites, wherein the gradient deriving module is configured to derive the feature map contribution parameter by normalizing the partial derivative over each pixel of the convolutional feature map.

Y. The system as paragraph X recites, wherein the gradient deriving module is configured to normalize the partial derivative by summing the partial derivative over each pixel of the convolutional feature map, and dividing the sum by the number of pixels.

Z. The system as paragraph T recites, further comprising a contribution weighting module configured to weight the feature map contribution parameter with regard to the feature vector.

AA. The system as paragraph Z recites, wherein the contribution weighting module is configured to weight the feature map contribution parameter by multiplying the feature map contribution parameter by the feature vector.

BB. The system as paragraph Z recites, wherein the localization map aggregating module is configured to aggregate feature map contribution parameters by aggregating weighted feature map contribution parameters.

CC. The system as paragraph T recites, wherein the localization map aggregating module is configured to aggregate feature map contribution parameters by summing a plurality of feature map contribution parameters for different corresponding feature vectors.

DD. The system as paragraph CC recites, wherein the localization map aggregating module is further configured to aggregate feature map contribution parameters by applying a non-linear transformation to the summed plurality of feature map contribution parameters.

EE. The system as paragraph DD recites, wherein the non-linear transformation comprises a rectifier function.

FF. The system as paragraph T recites, wherein the convolutional feature map has a one-to-one pixel correspondence to the localization map.

GG. The system as paragraph FF recites, wherein the segmentation map drawing module is configured to draw an edge of a segmentation map by assigning a first value to a pixel of the segmentation map corresponding to a first range of localization map values, and assigning a second value to a pixel of the segmentation map corresponding to a second range of localization map values exclusive of the first range of localization map values.

HH. The system as paragraph GG recites, wherein the first range of localization map values and the second range of localization map values are separated by a segmentation threshold value.

II. The system as paragraph T recites, further comprising a filter applying module configured to apply a filter to an image based on an edge of the segmentation map.

JJ. The system as paragraph II recites, wherein the image has a one-to-one pixel correspondence to the segmentation map.

KK. The system as paragraph JJ recites, wherein the filter applying module is configured to apply the filter to a pixel of the image corresponding to pixels of the segmentation map having a first value assigned.

LL. The system as paragraph II recites, wherein the filter comprises a Gaussian blur filter.

MM. A computer-readable storage medium storing computer-readable instructions executable by one or more processors, that when executed by the one or more processors, cause the one or more processors to perform operations comprising: deriving a gradient of a feature vector of a convolutional feature map; deriving a feature map contribution parameter with regard to the feature vector from the gradient of the feature vector; obtaining a localization map by aggregating feature map contribution parameters; and drawing an edge of a segmentation map based on values of the localization map.

NN. The computer-readable storage medium as paragraph MM recites, wherein the gradient of the feature vector is derived with regard to a classification.

OO. The computer-readable storage medium as paragraph NN recites, wherein the classification comprises one of two classes.

PP. The computer-readable storage medium as paragraph NN recites, wherein deriving the gradient of the feature vector comprises computing a partial derivative of a probability score of a feature of the convolutional feature map with regard to the classification over a feature vector of the convolutional feature map.

QQ. The computer-readable storage medium as paragraph PP recites, wherein deriving the feature map contribution parameter comprises normalizing the partial derivative over each pixel of the convolutional feature map.

RR. The computer-readable storage medium as paragraph QQ recites, wherein normalizing the partial derivative comprises summing the partial derivative over each pixel of the convolutional feature map, and dividing the sum by the number of pixels.

SS. The computer-readable storage medium as paragraph MM recites, wherein the operations further comprise weighting the feature map contribution parameter with regard to the feature vector.

TT. The computer-readable storage medium as paragraph SS recites, wherein weighting the feature map contribution parameter comprises multiplying the feature map contribution parameter by the feature vector.

UU. The computer-readable storage medium as paragraph SS recites, wherein aggregating feature map contribution parameters comprises aggregating weighted feature map contribution parameters.

VV. The computer-readable storage medium as paragraph MM recites, wherein aggregating feature map contribution parameters comprises summing a plurality of feature map contribution parameters for different corresponding feature vectors.

WW. The computer-readable storage medium as paragraph VV recites, wherein aggregating feature map contribution parameters further comprises applying a non-linear transformation to the summed plurality of feature map contribution parameters.

XX. The computer-readable storage medium as paragraph WW recites, wherein the non-linear transformation comprises a rectifier function.

YY. The computer-readable storage medium as paragraph MM recites, wherein the convolutional feature map has a one-to-one pixel correspondence to the localization map.

ZZ. The computer-readable storage medium as paragraph YY recites, wherein drawing an edge of a segmentation map comprises assigning a first value to a pixel of the segmentation map corresponding to a first range of localization map values, and assigning a second value to a pixel of the segmentation map corresponding to a second range of localization map values exclusive of the first range of localization map values.

AAA. The computer-readable storage medium as paragraph ZZ recites, wherein the first range of localization map values and the second range of localization map values are separated by a segmentation threshold value.

BBB. The computer-readable storage medium as paragraph MMM recites, wherein the operations further comprise applying a filter to an image based on an edge of the segmentation map.

CCC. The computer-readable storage medium as paragraph BBB recites, wherein the image has a one-to-one pixel correspondence to the segmentation map.

DDD. The computer-readable storage medium as paragraph CCC recites, wherein the filter is applied to a pixel of the image corresponding to pixels of the segmentation map having a first value assigned.

EEE. The computer-readable storage medium as paragraph BBB recites, wherein the filter comprises a Gaussian blur filter.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
deriving a gradient of a feature vector of a convolutional feature map;
deriving a feature map contribution parameter with regard to the feature vector from the gradient of the feature vector;
obtaining a localization map by aggregating feature map contribution parameters; and
drawing an edge of a segmentation map based on values of the localization map.

2. The method of claim 1, wherein the gradient of the feature vector is derived with regard to a classification.

3. The method of claim 2, wherein deriving the gradient of the feature vector comprises computing a partial derivative of a probability score of a feature of the convolutional feature map with regard to the classification over a feature vector of the convolutional feature map.

4. The method of claim 3, wherein deriving the feature map contribution parameter comprises normalizing the partial derivative over each pixel of the convolutional feature map.

5. The method of claim 4, wherein normalizing the partial derivative comprises summing the partial derivative over each pixel of the convolutional feature map, and dividing the sum by the number of pixels.

6. The method of claim 1, further comprising weighting the feature map contribution parameter with regard to the feature vector, wherein aggregating feature map contribution parameters comprises aggregating weighted feature map contribution parameters.

7. The method of claim 1, wherein aggregating feature map contribution parameters comprises summing a plurality of feature map contribution parameters for different corresponding feature vectors.

8. The method of claim 7, wherein aggregating feature map contribution parameters further comprises applying a non-linear transformation to the summed plurality of feature map contribution parameters.

9. The method of claim 1, wherein the convolutional feature map has a one-to-one pixel correspondence to the localization map.

10. The method of claim 9, wherein drawing an edge of a segmentation map comprises assigning a first value to a pixel of the segmentation map corresponding to a first range of localization map values, and assigning a second value to a pixel of the segmentation map corresponding to a second range of localization map values exclusive of the first range of localization map values, and
wherein the first range of localization map values and the second range of localization map values are separated by a segmentation threshold value.

11. A system comprising:
one or more processors; and
memory communicatively coupled to the one or more processors, the memory storing computer-executable modules executable by the one or more processors that, when executed by the one or more processors, perform associated operations, the computer-executable modules comprising:
a gradient deriving module configured to derive a gradient of a feature vector of a convolutional feature map;
a contribution deriving module configured to derive a feature map contribution parameter with regard to the feature vector from the gradient of the feature vector;
a localization map aggregating module configured to obtain a localization map by aggregating feature map contribution parameters; and
a segmentation map drawing module configured to draw an edge of a segmentation map based on values of the localization.

12. The system of claim 11, wherein the gradient deriving module is configured to derive the gradient of the feature vector with regard to a classification.

13. The system of claim 12, wherein the gradient deriving module is configured to derive the gradient of the feature vector by computing a partial derivative of a probability score of a feature of the convolutional feature map with regard to the classification over a feature vector of the convolutional feature map.

14. The system of claim 13, wherein the gradient deriving module is configured to derive the feature map contribution parameter by normalizing the partial derivative over each pixel of the convolutional feature map.

15. The system of claim 14, wherein the gradient deriving module is configured to normalize the partial derivative by summing the partial derivative over each pixel of the convolutional feature map, and dividing the sum by the number of pixels.

16. The system of claim 11, further comprising a contribution weighting module configured to weight the feature map contribution parameter with regard to the feature vector, wherein the localization map aggregating module is configured to aggregate feature map contribution parameters by aggregating weighted feature map contribution parameters.

17. The system of claim 11, wherein the localization map aggregating module is configured to aggregate feature map contribution parameters by summing a plurality of feature map contribution parameters for different corresponding feature vectors.

18. The system of claim 17, wherein the localization map aggregating module is further configured to aggregate feature map contribution parameters by applying a non-linear transformation to the summed plurality of feature map contribution parameters.

19. The system of claim 11, wherein the convolutional feature map has a one-to-one pixel correspondence to the localization map.

20. A computer-readable storage medium storing computer-readable instructions executable by one or more processors, that when executed by the one or more processors, cause the one or more processors to perform operations comprising:
deriving a gradient of a feature vector of a convolutional feature map;
deriving a feature map contribution parameter with regard to the feature vector from the gradient of the feature vector;
obtaining a localization map by aggregating feature map contribution parameters; and
drawing an edge of a segmentation map based on values of the localization map.
